(19) United States
(12) Patent Application Publication
(10) Pub. No.: US 2024/0423411 A1
(43) Pub. Date: Dec. 26, 2024

(54) SMART ELECTRIC ROASTER

(71) Applicant: Tae Joon PARK, Namyangju-si (KR)

(72) Inventor: Tae Joon PARK, Namyangju-si (KR)

(21) Appl. No.: 18/505,310

(22) Filed: Nov. 9, 2023

(30) Foreign Application Priority Data
Jun. 20, 2023 (KR) 10-2023-0079210

(51) Int. Cl. A47J 37/07; A47J 36/38; F24C 15/20

(52) U.S. Cl. CPC A47J 37/0754; A47J 36/38; A47J 37/0709; A47J 37/0763; F24C 15/2042

(57) ABSTRACT

Disclosed is a smart electric roaster, and more particularly, to a smart electric roaster, in which one of blowers provided on one or both sides of a roaster body is detachable to allow for easy installation on a table. According to the present invention as described above, the gently stepped portion that gently protrudes outward from the upper part of the outer circumference of the roaster body can reinforce the strength of the roaster body, and especially in the case where the blowers are provided on both sides of the outer circumference of the roaster body as in the present invention, can achieve the effect of minimizing the diameter size of the roaster body.

### CROSS-REFERENCE TO RELATED PATENT APPLICATION

This application claims the benefit of Korean Patent Application No. 10-2023-0079210, filed on Jun. 20, 2023, in the Korean Intellectual Property Office, the disclosure of which is incorporated herein in its entirety by reference.

### BACKGROUND OF THE INVENTION

### Field of the Invention

The present invention relates to a smart electric roaster, and more particularly, to a smart electric roaster, in which one of blowers provided on one or both sides of a roaster body is detachable to allow for easy installation on a table.

### Description of the Related Art

Generally, an electric roaster includes an electric heater built into the bottom of a housing of a certain size. On top of the electric heater, a roasting plate or frying pan is placed depending on the purpose, and the underside of the housing is provided with a drip pan to collect the oil generated when roasting meat, fish, shellfish, etc. Moreover, a housing cover is provided to cover the housing, and a control box that controls the temperature, while electric power is supplied to the electric heater, is provided on one side of the housing.

This type of electric roaster cannot internally remove the odor and smoke generated when roasting meat, fish, shellfish, etc. on the roasting plate or frying pan, causing them to remain in the surrounding space and irritate the user's nose and eyes, making it very uncomfortable to use.

As a solution to address this problem, a separate duct was installed on the top of the electric roaster to forcibly draw in and exhaust the odor and smoke to the outdoors using a fan.

However, when using such a duct, it caused a hindrance to conversations between people sitting across from each other, and the duct needed to be installed directly above the electric roaster to function properly. Furthermore, even when it was placed a little higher than the electric roaster, the smoke and odor were not properly removed and irritated the user's nose and eyes.

Meanwhile, Korean Utility Model Registration No.: 20-280338 (Registered on Jun. 19, 2002) discloses an air circulation structure for an electric roaster. The proposed air circulation structure is configured such that the smoke and odor contained in the air forcibly blown by a blowing fan are removed by an air purifier, making it possible to remove the smoke and odor generated when roasting meat, fish, shellfish, etc. on its own without the need for a separate duct. However, there are issues such as increased costs due to the necessity of additional deodorants, ozone generators, and anion generators. Furthermore, the oil contained in the air is adhered to the ozone and anion generators, resulting in lower efficiency or loss of operability.

### REFERENCES OF THE RELATED ART

### Patent Document 1:

Korean Utility Model Registration No.: 20-280338 (Registered on Jun. 19, 2002)

### SUMMARY OF THE INVENTION

The present invention has been made in an effort to solve the above-described problems associated with prior art, and an object of the present invention is to provide a smart electric roaster in which blowers are provided on both sides of a roaster body to prevent the diffusion of smoke, oil and odor generated during the roasting process into the surroundings, and one of the blowers is configured to be detachable, facilitating easy installation or assembly when it is inserted into a roaster fixing hole formed on a dining table or table without interference.

An object of the present invention is to provide a smart electric roaster (A) comprising a roaster body 10 having a cylindrical shape with a wide top and narrow bottom; a support portion 20 provided below a base plate 110 of the roaster body 10; a blower 30 protruding externally from an outer circumference 120 of the roaster body 10; and a roasting unit 40 provided inside the roaster body 10, characterized in that the roaster body 10 includes a first through-hole 111 formed in the center of the base plate 110 and an engaging portion 121 protruding externally from the top of the outer circumference 120 of the roaster body 10, wherein a discharge outlet 312 protruding downward is provided at the lower part of the blower 30, wherein an inlet duct 230 is provided on a lower side wall of the support portion 20, into which the discharge outlet 312 of the blower 30 is fitted, wherein the roasting unit 40 is provided on the top of the base plate 110 inside the roaster body 10, the roasting unit 40 comprises, from the bottom, a heating support portion 410, a heating unit 420, and a roasting support portion 430, wherein the heating support portion 410 of the roasting unit 40 comprises a cylindrical support cap 411, an inner inlet hole 411-1 on the outer circumference of a cylindrical support cap 411, an inner outlet hole 411-2 on the top, and a flange 412 protruding externally from the bottom, such that the flange 412 of the heating support portion 410 is coupled to the base plate 110 of the roaster body 10. One or two blowers 30 may be provided on the outer circumference 120 of the roaster body 10.

The roaster body 10 may comprise a gently stepped portion 122 that gently protrudes outward from an upper part of the outer circumference 120.

The support portion 20 may comprise a wire storage space 210 in which a wire (W) is stored at the top and an oil storage space 220 in which oil accumulates at the bottom of the wire storage space 210, the wire storage space 210 and the oil storage space 220 being separately provided.

A second through-hole 211a may be formed in the center of a wire storage plate 211 at the bottom of the wire storage space 210.

The blower 30 may be provided on both sides of the lower part of the outer circumference 120 of the roaster body 10, respectively, wherein the blower 30 on one side is detachably coupled to a blower receiving portion 130 provided on one side of the roaster body 10, and the blower 30 on the other side is fixedly coupled to another blower receiving portion 130 provided on the other side of the roaster body 10, wherein the inlet duct 230 on one side, into which the discharge outlet 312 of the blower 30 is fitted, is detachably coupled to the lower part of the support portion 20 by clamps 231, and the inlet duct 230 on the other side is fixedly coupled to the lower part of the support portion 20.

The heating unit 420 of the roasting unit 40 may comprise a heating lamp 421 supported by a lamp support piece 422 at the top of the inside of a lamp case 423 in the form of a bowl that widens towards the top, and the lamp support piece 422 may be configured to be slightly moveable from side to side within the lamp case 423.

The lower part of the lamp case 423 of the heating unit 420 of the roasting unit 40 may be provided with a case bottom 423-2 that is convex toward the central top, and a temperature sensing unit 426 may be provided at the central top of the case bottom 423-2. The temperature sensing unit 426 not only prevents interference during use, but also aids in preventing overheating.

According to the present invention as described above, the gently stepped portion that gently protrudes outward from the upper part of the outer circumference of the roaster body can reinforce the strength of the roaster body, and especially in the case where the blowers are provided on both sides of the outer circumference of the roaster body as in the present invention, can achieve the effect of minimizing the diameter size of the roaster body.

Moreover, according to the present invention, the blowers provided on both sides of the roaster body can increase the suction and discharge power, thereby preventing the diffusion of smoke, oil and odor generated during the roasting process into the surroundings, resulting in a pleasant surrounding environment.

Meanwhile, according to the present invention, any one of the blowers provided on both sides of the roaster body is detachably provided, facilitating the insertion into the roaster fixing hole formed on a table or dining table having a limited area.

Furthermore, according to the invention, the wire storage space separately provided below the base plate of the roaster body can prevent oil generated during the roasting process from adhering to the wire.

In addition, according to the present invention, since the lamp support piece provided at the top of the inside of the lamp case of the heating unit can be slightly moved from side to side within the lamp case, it is possible to prevent the occurrence of cracks or deformations in the heating lamp due to differences in elongation caused by repeated use of the heating lamp.

Additionally, according to the present invention, since the lower part of the lamp case of the heating unit of the roasting unit is provided with the case bottom that is convex toward the central top and the temperature sensing unit 426 is provided at the central top of the case bottom, it is possible to not only prevent interference during use, but also aid in preventing overheating, resulting in an extended lifespan.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating a smart electric roaster according to the present invention;

FIG. 2 is a rear perspective view illustrating the smart electric roaster according to the present invention;

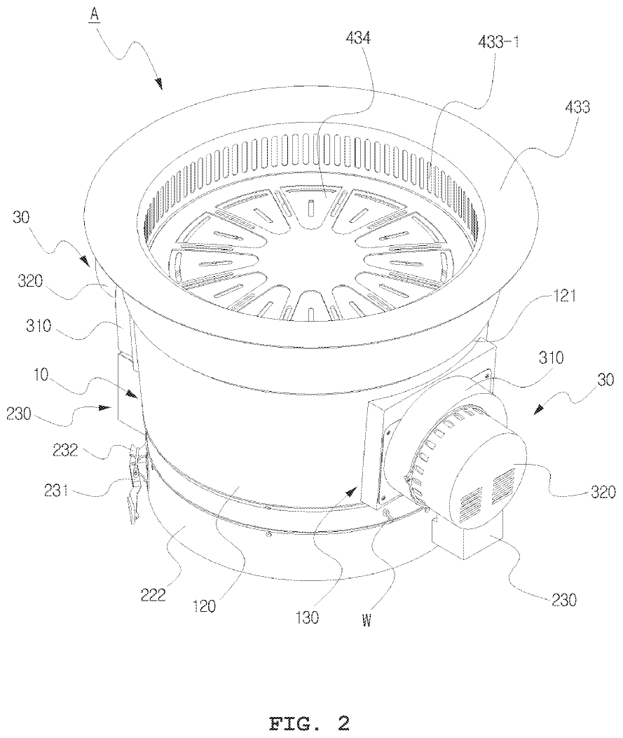

FIG. 3 is an exploded perspective view illustrating the smart electric roaster according to the present invention; and

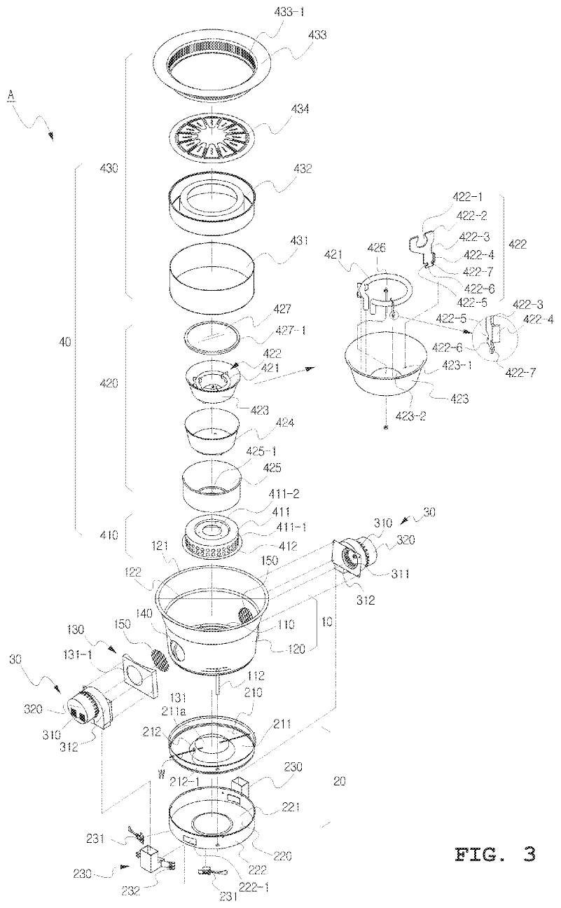

FIG. 4 is a longitudinal cross-sectional view illustrating a smart electric roaster according to the present invention.

### DETAILED DESCRIPTION OF THE INVENTION

Hereinafter, preferred embodiments according to the present invention will be described in detail with reference to the accompanying drawings.

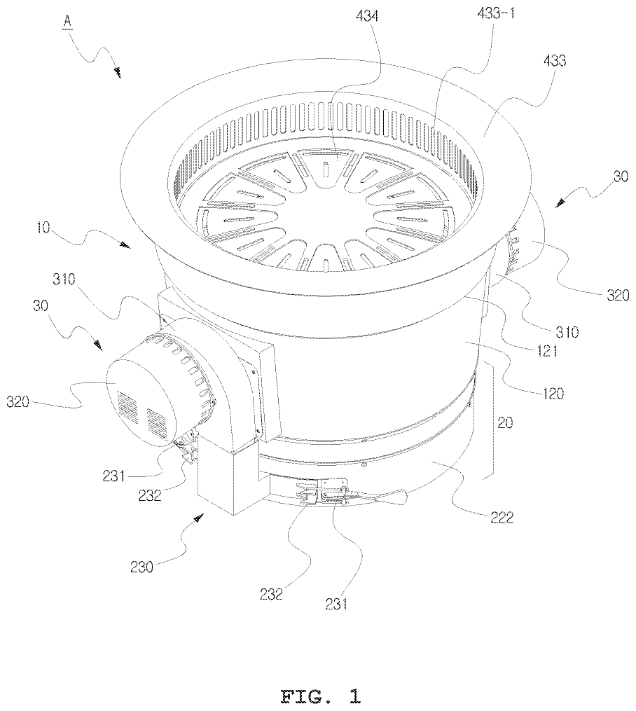

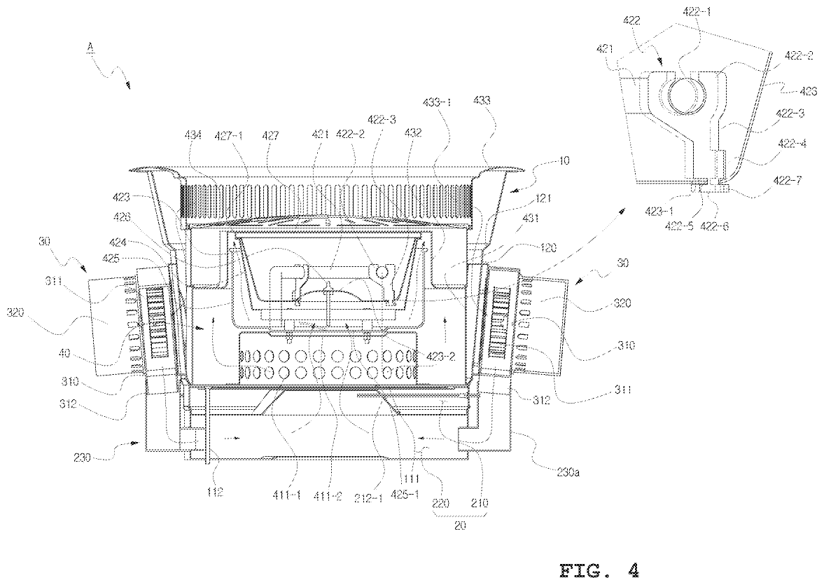

The smart electric roaster (A) according to the present invention is configured to facilitate its installation on a table or dining table while preventing interference with the roaster fixing hole during the installation and to prevent the diffusion of smoke, oil, and odor generated during the roasting process into the surroundings. As illustrated in FIGS. 1 and 4, the smart electric roaster (A) may comprise a roaster body 10, a support portion 20, a blower 30, and a roasting unit 40.

The roaster body 10 may have an open-top cylindrical shape with a wide top and narrow bottom to maximize space utilization, where the support portion 20 is provided below a base plate 110 of the roaster body 10, and the blower 30 is provide on an outer circumference 120 of the roaster body 10, allowing the smoke, oil, and odor generated during roasting to be drawn in from upper space of the roaster body 10 and undergo recombustion therein.

To this end, a first through-hole 111 having a predetermined diameter is formed in the center of the base plate 110 of the roaster body 10 such that the smoke, oil and odor generated during roasting are supplied to a heating unit 420 of the roasting unit 40 via a second through-hole 211a formed in a wire storage plate 211 of the support portion 20, which will be described later, for recombustion, and then recirculated through a roasting support portion 430 and the blower 30, resulting in complete removal of smoke, oil and odor due to complete combustion.

An engaging portion 121 protrudes externally from the top of the outer circumference 120 of the roaster body 10. Moreover, a gently stepped portion 122 that gently protrudes outward is also provided at an upper part of the outer circumference 120 of the roaster body 10. The presence of the engaging portion 121 and the gently stepped portion 122 provided on the outer circumference 120 of the roaster body 10 ensures that the roaster body 10 maintains sufficient strength. In particular, even in the case where two blowers 30 are provided on both sides of the outer circumference 120 of the roaster body 10, the presence of the gently stepped portion 122 can minimize the diameter size of the roaster body 10.

The gently stepped portion 122 is intended to reinforce the strength of the roaster body 10. Especially, in the case where the blowers 30 are provided on both sides of the outer circumference 120 of the roaster body 10 as in the present invention, the gently stepped portion 122 is an essential component to minimize the diameter size of the roaster body 10.

The blower 30 is provided on the outer circumference 120 of the roaster body 10, and a fifth through-hole 140 is provided on the outer circumference 120 of the roaster body 10 including the blower 30. Moreover, a blower receiving portion 130 is provided in the fifth through-hole 140, and the blower receiving portion 130 includes a fourth through-hole 131-1 formed in a receiving panel 131 having a flat plate shape. A filter mesh 150 is provided between the fifth through-hole 140 provided on the outer circumference 120 of the roaster body 10 and the fourth through-hole 131-1 of the blower receiving portion 130.

The base plate 110 of the roaster body 10 has a large circular first through-hole 111 formed in the center, and a ring-shaped groove is integrally formed on the outside of the first through-hole 111. Furthermore, an oil discharge pipe 112 having a predetermined length is formed to protrude downward in the ring-shaped groove, and the oil discharge pipe 112 penetrates the lower part of the support portion 20 provided below the roaster body 10, allowing the oil to be discharged to the lower part of the support portion 20. In addition, the oil discharge pipe 112 allows the oil to be simultaneously processed using a drip pan (not shown) provided at the lower part of the support portion 20.

Additionally, a wire storage space 210 is provided at the lower part of the support portion 20 to allow the wire (W) required for driving the blower 30 to be separated from the oil storage space 220, which prevents the oil generated during the roasting process from adhering to the surface of the wire (W), thereby preventing the occurrence of short circuit, resulting in an extended lifespan.

The second through-hole 211a formed in the center of the wire storage plate 211 of the wire storage space 210 includes a protruding tapered portion 212 that is tapered upward to prevent the wire (W) from easily falling into the oil storage space 220 at the bottom.

The protruding tapered portion 212 not only facilitates the upward movement of smoke including oil, but also prevents the oil from flowing into the wire storage space 210 in the opposite direction from the top, that is, toward the bottom.

The protruding tapered portion 212 includes a wire through-hole 212-1 having a predetermined diameter on its inclined surface, allowing the wire (W) to pass therethrough, thereby facilitating wiring work.

The second through-hole 211a is formed in the center of the wire storage plate 211 located below the wire storage space 210, allowing the smoke mixed with external air during the roasting process to move easily towards the heating unit 420 of the roasting unit 40.

The blower 30 provided on the outer circumference 120 of the roaster body 10 draws in the smoke, oil, and odor generated during the roasting process from a roasting plate 434 along with the external air, allowing for continuous circulation through the oil storage space 220 and the wire storage space 210 of the support portion 20, and the heating support portion 410, the heating unit 420, and a roasting plate support portion 433 of the roasting unit 40.

Moreover, the blower 30 includes a fan 311 within a blower body 310 and a discharge outlet 312 protruding downward from the bottom of the blower 30. The fan 311 is driven by a drive motor 320 connected thereto. In the case where the blowers 30 are provided on both sides of the roaster body 10, the blower 30 on one side is detachably coupled to the blower receiving portion 130 of the roaster body 10 by means of screws, and the blower 30 on the other side is fixedly coupled thereto.

Inlet ducts 230 into which the discharge outlets 312 of the blowers 30 are fitted are L-shaped and provided at the lower part of the support portion 20. Like the blowers 30, the inlet duct 230 on one side is detachably coupled to the lower part of the support portion 20 by clamps 231, and the inlet duct 230 on the other side is fixedly coupled to the lower part of the support portion 20. That is, the inlet duct 230 is inserted into a third through-hole 222-1 provided on a side wall 222 of the outer circumference of the oil storage space 220 of the support portion 20.

Among the inlet ducts 230, the L-shaped detachable inlet duct 230 at one side is brought into contact with the third through-hole 222-1 provided on the side wall 222 of the outer circumference of the oil storage space 220 of the support portion 20. Then, the lower part of the inlet duct 230 is inserted into the third through-hole 222-1, and the clamps 231 are fastened with rivets on both sides of the third through-hole 222-1.

Clamp brackets 232 are provided on both sides of the inlet duct 230 such that the clamps 231 provided on both sides of the third through-hole 222-1 are detachably coupled to the clamp brackets 232 provided on both sides of the inlet duct 230.

As a result, in the case where the blowers 30 are provided on both sides of the roaster body 10, when the roaster body 10 is inserted from the top to the bottom into the roaster fixing hole provided on a table or dining table, it is possible to prevent the roaster body 10 from being unable to be inserted into the roaster fixing hole provided on the table or dining table.

Moreover, even if one of the two inlet ducts 230 is coupled to the side wall 222 of the outer circumference of the oil storage space 220 of the support portion 20, its width is configured to be smaller than the roaster fixing hole of the table, making it easy to insert, and the other inlet duct 320 is coupled by means of screws while one side of the other inlet duct 320 is already inserted, like the blower 30.

The blower 30 is provided with a drive motor 320 that is connected to the fan 311 on the exterior of the blower body 310 and driven by a switch (not shown).

The discharge outlet 312 of the blower 30 is connected to the inlet duct 230 provided in the oil storage space 220.

The clamps 231 are fastened with rivets on both sides of the third through-hole 222-1 of the side wall 222 of the oil storage space 220 where the detachable inlet duct 230 is provided, and then the clamps 231 are engaged with the clamp brackets 232 provided on both sides of the detachable inlet duct 230, ensuring a locked state and preventing detachment during use.

The roasting unit 40 is provided on the inner upper side of the roaster body 10 in such manner that the heating unit 420 is received on the heating support portion 410 provided on the upper part of the base plate 110 of the roaster body 10 and then the roasting support portion 430 is placed on the upper part of the heating unit 420, ensuring that sufficient heat required for roasting is supplied and the odor and oils generated during the roasting process can be removed through complete combustion.

The heating support portion 410 allows air from the oil storage space 220 to flow into the interior of the roaster body 10 through the inner inlet hole 411-1 and then circulate through an inner outlet hole 411-2 to reach the heating unit 420.

The heating lamp 421 of the heating unit 420 can be slightly moved from side to side inside, from the outside to the inside or from the inside to the outside within the lamp case 423 by the lamp support piece 422.

To this end, the lamp support piece 422 includes a lamp support head 422-2 having an open-top circular receiving groove 422-1, into which the heating lamp 421 can be inserted and stably supported, a gap-maintaining piece 422-3 having a predetermined height or length provided at the lower part of the lamp support head 422-2, and an upper engaging portion 422 provided at the lower part of the gap-maintaining piece 422-3 so that the gap-maintaining piece 422-3 is engaged with a slide hole 432-1 provided in the lamp case 423, thereby preventing the gap-maintaining piece 422-3 from moving downward.

Notch grooves 422-5 are provided on both sides of the lower part of the gap-maintaining piece 422-3 including the upper engaging portion 422-4, and a lower engaging portion 422-6 are provided at the lower part of the notch grooves 422-5. The notch grooves 422-5 are inserted into the slide hole 423-1 of the lamp case 423 and maintained in that state. The lower engaging portion 422-6 includes a bent engaging piece 422-7 that is bent on one end while being inserted into the slide hole 423 of the lamp case 423 and exposed downward. This bent engaging piece 422-7 can prevent the gap-maintaining piece 422-3 of the lamp support piece 422 from moving upward and being disengaged from the slide hole 423-1. As a result, as shown in the enlarged view on the right of FIG. 4, the lamp support piece 422 can be slightly moved from side to side, thereby preventing the occurrence of cracks or deformations due to differences in elongation caused by repeated use of the heating lamp 421.

Moreover, the heating lamp 421 is located at a certain distance from the bottom and side walls of the lamp case 423, and an insulating case 425 is provided on the outer side of the lamp case 423.

Furthermore, a reinforced insulating case 424 may be provided between the lamp case 423 and the insulating case 425 to enhance the insulation effect.

A disc-shaped protective plate 427 is placed on the top of the lamp case 423 of the heating unit 420, and a ring-shaped fixing ring 427-1 is provided at the edge of the protective plate 427, thereby preventing the oil and foreign substances from falling into the lamp case 423 and the heating lamp 421 during use.

In addition, the lower part of the lamp case 423 of the heating unit 420 of the roasting unit 40 is provided with a case bottom 423-2 that is convex toward the central top, and a temperature sensing unit 426 is provided at the central top of the case bottom 423-2. The temperature sensing unit 426 is stably coupled with nuts provided at the top and bottom of the case bottom 423-2.

The roasting support portion 430 of the roasting unit 40 is configured for direct roasting, which includes a gap-maintaining ring 431, an oil collecting plate 432, a roasting plate support portion 433, and a roasting plate 434 which are sequentially assembled from the bottom to the top. The bottom of the oil collecting plate 432 is supported on the top of the gap-maintaining ring 431, and a stepped portion is formed at the bottom of the oil collecting plate 432 to be supported on the top of the gap-maintaining ring 431. In order for the roasting plate 434 to be received on the top of the oil collecting plate 432 engaged with the roasting plate support portion 433, the oil collecting plate 432 has a horizontal engaging portion extending outward on its top and a vertical portion extending upward at the edge of the horizontal engaging portion. As a result, the horizontally extending engaging portion is engaged with a support engaging portion provided toward the inside of the bottom of the roasting plate support portion 433, and the roasting plate 434 is received and supported on the top of the horizontal engaging portion extending outward on the top of the oil collecting plate 432.

Furthermore, an outer inlet hole 433-1 in the form of a vertical long hole is provided on the side wall of the roasting plate support portion 433.

Two blowers 30 may be provided on both sides of the outer circumference 120 of the roaster body 10. In this case, one blower 30 is first separated on one side of the roaster body 10, one inlet duct 230 is separated on one side of the support portion 20, and in this state the other blower 30 and the other inlet duct 230 are coupled on the other side. At this time, with the roaster body 10 tilted at about 45°, the blower is inserted from the top to the bottom into the roaster fixing hole provided in a table (not shown), allowing the top of the roaster body 10 to be engaged therein.

Next, the blower body 310 is brought into contact with the blower receiving portion 130 of the roaster body 10 exposed at the bottom of the table and then coupled by means of screws.

Subsequently, the top of the detachable inlet duct 230 is inserted into the discharge outlet 312 located at the lower part of the blower body 310, the bottom of the detachable inlet duct 230 is inserted into the third through-hole 222-1 provided on the side wall 222 of the oil storage space 220, and then the clamps 231 are engaged with the clamp brackets 232.

The roasting process with the smart electric roaster (A) installed on the table is performed as follows. First, the odor and oil generated during the cooking process of the food placed on the roasting plate 434 of the roasting support portion 430 are drawn into the interior of the blower 30 through the outer inlet hole 433-1 of the roasting plate support portion 433 by the suction power generated by the operation of the blower 30, and then moved to the oil storage space 220.

Subsequently, the odor and oil generated during the cooking process of the food placed on the roasting plate 434 of the roasting support portion 430 are directed through the second through-hole 211a of the wire storage space 210 and the inner inlet hole 411-1 of the support cap 411 of the heating support portion 410 and then pass between the insulating case 425 and the reinforced insulating case 424, where they undergo recombustion due to the generated heat from the heating unit 420. Then, the air from which oil and odors have been removed due to the recombustion passes again through the roasting plate 434 and then circulates through the outer inlet hole 433-1 of the roasting plate support portion 433, thereby preventing the diffusion of odors into the surroundings.

### Brief Description of Reference Numerals

10: roaster body 20: support portion
30: blower 110: base plate
111: first through-hole 120: outer circumference
122: gently stepped portion 210: wire storage space
211a: second through-hole 212: tapered portion
220: oil storage space 221: oil storage plate

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A smart electric roaster (A) comprising: a roaster body (10) having a cylindrical shape with a wide top and narrow bottom; a support portion (20) provided below a base plate (110) of the roaster body (10); a blower (30) protruding externally from an outer circumference (120) of the roaster body (10); and a roasting unit (40) provided inside the roaster body (10), characterized in that:
the roaster body (10) includes a first through-hole (111) formed in the center of the base plate (110) and an engaging portion (121) protruding externally from the top of the outer circumference (120) of the roaster body (10), wherein a discharge outlet (312) protruding downward is provided at the lower part of the blower (30), wherein an inlet duct (230) is provided on a lower side wall of the support portion (20), into which the discharge outlet (312) of the blower (30) is fitted, wherein the roasting unit (40) is provided on the top of the base plate (110) inside the roaster body (10), the roasting unit (40) comprises, from the bottom, a heating support portion (410), a heating unit (420), and a roasting support portion (430), wherein the heating support portion (410) of the roasting unit (40) comprises a cylindrical support cap (411), an inner inlet hole (411-1) on the outer circumference of a cylindrical support cap (411), an inner outlet hole (411-2) on the top, and a flange (412) protruding externally from the bottom, such that the flange (412) of the heating support portion (410) is coupled to the base plate (110) of the roaster body (10), and wherein the support portion (20) comprises a wire storage space (210) in which a wire (W) is stored at the top and an oil storage space (220) in which oil accumulates at the bottom of the wire storage space (210), the wire storage space (210) and the oil storage space (220) being separately provided.

2. The smart electric roaster (A) of claim 1, wherein the roaster body (10) comprises a gently stepped portion (122) that gently protrudes outward from the upper part of the outer circumference (120).

3. The smart electric roaster (A) of claim 1, wherein a second through-hole (211a) is formed in the center of a wire storage plate (211) at the bottom of the wire storage space (210).

4. A smart electric roaster (A) comprising a roaster body (10) having a cylindrical shape with a wide top and narrow bottom, a support portion (20) provided below a base plate (110) of the roaster body (10), a blower (30) protruding externally from an outer circumference (120) of the roaster body (10), and a roasting unit (40) provided inside the roaster body (10), characterized in that:
the roaster body (10) includes a first through-hole (111) formed in the center of the base plate (110) and an engaging portion (121) protruding externally from the top of the outer circumference (120) of the roaster body (10), wherein a discharge outlet (312) protruding downward is provided at the lower part of the blower (30), wherein an inlet duct (230) is provided on a lower side wall of the support portion (20), into which the discharge outlet (312) of the blower (30) is fitted, wherein the roasting unit (40) is provided on the top of the base plate (110) inside the roaster body (10), the roasting unit (40) comprises, from the bottom, a heating support portion (410), a heating unit (420), and a roasting support portion (430), wherein the heating support portion (410) of the roasting unit (40) comprises a cylindrical support cap (411), an inner inlet hole (411-1) on the outer circumference of a cylindrical support cap (411), an inner outlet hole (411-2) on the top, and a flange (412) protruding externally from the bottom, such that the flange (412) of the heating support portion (410) is coupled to the base plate (110) of the roaster body (10), wherein the blower (30) is provided on both sides of the lower part of the outer circumference (120) of the roaster body (10), respectively, wherein the blower (30) on one side is detachably coupled to a blower receiving portion (130) provided on one side of the roaster body (10), and the blower (30) on the other side is fixedly coupled to another blower receiving portion (130) provided on the other side of the roaster body (10), wherein the inlet duct (230) on one side, into which the discharge outlet (312) of the blower (30) is fitted, is detachably coupled to the lower part of the support portion (20) by clamps (231), and the inlet duct (230) on the other side is fixedly coupled to the lower part of the support portion (20).

5. A smart electric roaster (A) comprising a roaster body (10) having a cylindrical shape with a wide top and narrow bottom, a support portion (20) provided below a base plate (110) of the roaster body (10), a blower (30) protruding externally from an outer circumference (120) of the roaster body (10), and a roasting unit (40) provided inside the roaster body (10), characterized in that:
wherein the roasting unit (40) is provided on the top of the base plate (110) inside the roaster body (10), the roasting unit (40) comprises, from the bottom, a heating support portion (410), a heating unit (420), and a roasting support portion (430), wherein the heating support portion (410) of the roasting unit (40) comprises a cylindrical support cap (411), an inner inlet hole (411-1) on the outer circumference of a cylindrical support cap (411), an inner outlet hole (411-2) on the top, and a flange (412) protruding externally from the bottom, such that the flange (412) of the heating support portion (410) is coupled to the base plate (110) of the roaster body (10),
wherein the heating unit (420) of the roasting unit (40) comprises a heating lamp (421) supported by a lamp support piece (422) at the top of the inside of a lamp case (423) in the form of a bowl that widens towards the top, and the lamp support piece (422) is configured to be slightly moveable from side to side, from the outside to the inside or from the inside to the outside within the lamp case (423).

6. A smart electric roaster (A) comprising a roaster body (10) having a cylindrical shape with a wide top and narrow bottom, a support portion (20) provided below a base plate (110) of the roaster body (10), a blower (30) protruding externally from an outer circumference (120) of the roaster body (10), and a roasting unit (40) provided inside the roaster body (10), characterized in that:
wherein the roasting unit (40) is provided on the top of the base plate (110) inside the roaster body (10), the roasting unit (40) comprises, from the bottom, a heating support portion (410), a heating unit (420), and a roasting support portion (430), wherein the heating support portion (410) of the roasting unit (40) comprises a cylindrical support cap (411), an inner inlet hole (411-1) on the outer circumference of a cylindrical support cap (411), an inner outlet hole (411-2) on the top, and a flange (412) protruding externally from the bottom, such that the flange (412) of the heating support portion (410) is coupled to the base plate (110) of the roaster body (10), wherein the lower part of the lamp case (423) of the heating unit (420) of the roasting unit (40) is provided with a case bottom (423-2) that is convex toward the central top, and wherein a temperature sensing unit (426) is provided at the central top of the case bottom (423-2).
